(19) United States
(12) Patent Application Publication
(10) Pub. No.: US 2026/0043964 A1
(43) Pub. Date: Feb. 12, 2026

(54) EFFICIENT AND COMPACT MID-INFRARED POLARIZATION SPLITTER AND ROTATOR BASED ON A BIFURCATED TAPERED-BENT WAVEGUIDE

(71) Applicant: Khalifa University of Science and Technology, Abu Dhabi (AE)

(72) Inventors: Mauro Fernandes Pereira, Jr., Abu Dhabi (AE); Humaira Zafar, Abu Dhabi (AE)

(21) Appl. No.: 18/800,847

(22) Filed: Aug. 12, 2024

(51) Int. Cl. G02B 6/27

(52) U.S. Cl. CPC G02B 6/2726; G02B 6/2773

(57) ABSTRACT

A method for a compact mid-infrared polarization splitter and rotator (PSR) that may include receiving an input signal at a waveguide, the input signal having a transverse electric (TE) mode and a transverse magnetic (TM) mode such that the TE mode may be a zero order or higher mode. The method may further include conditioning, by a taper of the waveguide, the input signal to convert the TM mode to an additional TE mode and bifurcating, after the conditioning and by a bifurcation section of the waveguide positioned after the taper, the input signal may be split into a first branch and a second branch of the waveguide. The method may further include outputting, out of the first branch, a first output signal having the TE mode and outputting, out of the second branch, a second output signal.

The present disclosure is directed to a polarization splitter and rotator system, components, devices, and methods. More particularly, the present disclosure describes a mid-infrared polarization splitter and rotator.

### BACKGROUND

The silicon photonics waveguide commercial industry is a billion-dollar industry with the demand for newer and more efficient photonics technologies in the mid-infrared spectral region increasing each year. The mid-infrared (MIR) spectral region may span mid-infrared wavelengths between three and thirty micrometers (μm) and holds significant importance in various fields like thermal imaging, medical diagnosis, and security. Integrating a waveguide spectrometer onto a platform typically may use devices with excessively large spatial footprints around from 1,600 μm up to two millimeters (mm) to achieve desired results. These platforms typically take up too much space, are inconvenient to retrofit into existing systems, and have conventionally failed to provide desired modes of light without significant losses in the mid-infrared range. Additionally, many systems which use complementary metal-oxide semiconductor (CMOS) technology which require using a specific polarization state, such as transverse electric (TE) modes. These systems may use a polarization splitter and rotator converter to change transverse magnetic (TM) mode of a signal to a TE mode for proper operation.

### BRIEF SUMMARY

In some embodiments, a method using a compact mid-infrared polarization splitter and rotator may include receiving an input signal at a waveguide, the input signal having a transverse electric (TE) mode and a transverse magnetic (TM) mode, wherein the TE mode is a zero order mode or higher. The method may further include conditioning, by a taper of the waveguide, the input signal which may convert the TM mode to an additional TE mode such that the additional TE mode may be a zero order mode or higher, and bifurcating, after the conditioning and by a bifurcation section of the waveguide positioned after the taper, the input signal into a first branch and a second branch of the waveguide. In some embodiments, the method may output, out of the first branch, a first output signal having the TE mode and output, out of the second branch, a second output signal.

In some embodiments, conditioning may include rotating the TM mode into the additional TE mode, and the second branch conditions the additional TE mode of the input signal into the second output signal having a zero order TE mode.

In some embodiments, the input signal may have a wavelength in a range between 2.0 μm and 15.0 μm.

In some embodiments, the range may be between 3.1 μm and 3.5 μm and a polarization conversion loss of the second output signal may be less than or equal to 0.5 dB.

In some embodiments, a polarization conversion loss of the second output signal may be less than 0.9 dB and an insertion loss at the first output signal may be less than or equal to 0.5 dB.

In some embodiments, at least one crosstalk value between the first output signal and the second output signal may be less than 20 dB.

In some embodiments, a device may include a substrate and a waveguide coupled to the substrate and configured to receive an input signal having a transverse electric (TE) mode and a transverse magnetic (TM) mode. In some examples the TE mode may be a zero order or higher TE mode. The device may further include a taper of the waveguide configured to condition the input signal to convert the TM mode to an additional TE mode such that the additional TE mode may be a zero order or higher TE mode, and a bifurcation section of the waveguide after the taper forming a first branch and a second branch of the waveguide such that the first branch may be configured to diverge from the second branch after the bifurcation section and the first branch may be configured to output a first output signal having the TE mode. In some embodiments, the second branch may be configured to condition the additional TE mode into a zero order TE mode, and configured to output a second output signal having the zero order TE mode.

In some embodiments, the first branch and the second branch may each be configured to curve after the bifurcation section.

In some embodiments, the first branch may have a first taper which widens after the bifurcation section and the second branch has a second taper which may narrow after the bifurcation section.

In some embodiments, the taper may include a length between seven μm and fifteen μm prior to the bifurcation section.

In some embodiments, the substrate may have a length which extends along the waveguide, the taper, the first branch, and the second branch, such that the length may be between fifty μm and one hundred μm.

In some embodiments, the first branch may include a first width and the second branch may include a second width such that at a distance after the bifurcation section the first width may be greater than the second width.

In some embodiments, the second branch may include a first curve and a second curve such that the first curve may include a radius of curvature between two μm and twelve μm and the second curve may include a radius of curvature between seven μm and seventeen μm. In some embodiments, the first branch may include a first S-bend and a second S-bend which may include a combined radius of curvature between three μm and thirteen μm.

In some embodiments, the bifurcation section may include a slot with a width between fifty nm and one hundred and forty nm.

In some embodiments, the first branch and the second branch may have a thickness measured from a surface of the substrate between 400 nm and 600 nm.

In some embodiments, at a distance after the bifurcation section the first branch and the second branch may each taper into fully-etched waveguides over a length between five μm and twenty μm.

In some embodiments, a waveguide configured to receive an input signal which may have a transverse electric (TE) mode and a transverse magnetic (TM) mode such that the TE mode may be a zero order or higher TE mode. In some embodiments, the apparatus may include a taper of the waveguide such that the taper may be configured to condition the input signal to convert the TM mode to an additional TE mode such that the additional TE mode may be a zero order or higher mode. The apparatus may further include a first branch coupled to the taper such that the first branch may be configured to output a first output signal having the TE mode. In some embodiments, the apparatus may further include a second branch coupled to the taper such that the second branch is configured condition the additional TE mode into a zero order TE mode, and configured to output a second output signal having the zero order TE mode.

In some embodiments, the first branch and the second branch may have equal widths at a bifurcation section of the waveguide such that the first branch and the second branch are each coupled to the taper.

In some embodiments, the first branch may curve after the taper at an angle between ten and thirty five degrees.

In some embodiments, the waveguide, taper, first branch, and second branch may be at least partially coupled to a substrate and the waveguide, taper, first branch, and second branch may be at least partially encapsulated by a silicon dioxide (SiO2) layer.

In some embodiments, various technical features, aspects, and advantages of the present disclosure are readily appreciated from the following detailed description. The present disclosure should not be considered limiting, and one or more embodiments discussed herein may be combined in various non-limiting ways. Some or all embodiments herein may be modified without departing from the scope of the present disclosure. The detailed description and drawings may be illustrative of the present disclosure such that advantages of the invention will be demonstrated.

### BRIEF DESCRIPTION OF THE DRAWINGS

The foregoing aspects and many of the advantages of the present disclosure will become more readily appreciated as these advantages become better understood by reference to the following detailed description, when taken in conjunction with the accompanying drawings.

FIG. 1 is an example illustration of a mid-infrared polarization splitter and rotator, according to some embodiments.

FIG. 2 is an example diagram of a mid-infrared polarization splitter and rotator, according to some embodiments.

FIG. 3 is an example set of TE/TM mode images of a mid-infrared polarization splitter and rotator, according to some embodiments.

FIG. 4 is an example set of TE/TM transmission spectra from a mid-infrared polarization splitter and rotator in a mid-infrared wavelength range, according to some embodiments.

FIG. 5 is an example flow diagram for a mid-infrared polarization splitter and rotator, according to some embodiments.

FIG. 6 is an example block diagram for mid-infrared polarization splitter and rotators, according to some embodiments.

In the drawings, like reference numerals refer to like parts throughout the various views and embodiments unless otherwise specified. Not all instances of an element are necessarily labeled to improve clarity in the drawings where appropriate. The drawings are not necessarily to scale, emphasis instead being placed upon illustrating the principles being described.

### DETAILED DESCRIPTION

Embodiments are described below in the context of a mid-infrared polarization splitter and rotator. In an example, the mid-infrared (MIR) spectral region may span three to thirty micrometer (μm) wavelengths and may hold significant importance in various fields like thermal imaging, medical diagnosis, and security. Integrating a waveguide spectrometer onto a single platform with a source, detector, and passive waveguides may greatly decrease size and cost. For example, the silicon-on-insulator (SOI) platform may be used in integrated photonics because SOI platforms may be highly compatible with complementary metal-oxide semiconductor (CMOS) technology, easy to make, mature, and stable. Silicon waveguides remain viable up to 3.8 μm wavelength when covered with SiO₂ on both the top and bottom, while in the mid-infrared spectrum around two to seven μm, silicon's low absorption loss is sustained with suspended silicon waveguides where buried SiO₂ is etched away, and there's no SiO₂ covering from the top. This spectrum is crucial for sensing gases like carbon monoxide (CO), methane (CH₄), carbon sulfide (OCS), ammonia (NH₃), carbon dioxide (CO₂), and nitric oxide (NO).

In some examples, the source for MIR spectral regions may be provided by optical sources such as lasers, quantum cascade lasers (QCL), or other optical signal generators. In a non-limiting example utilizing a QCL for input, transverse magnetic (TM) waveguide modes may be generated. Converting the TM waveguide modes to transverse electric (TE) modes in a compact and efficient manner provides improvement as many modern on-chip devices are optimized for TE modes. TE modes may provide benefits like smaller bending radii and better modal overlap for sensing in slot waveguides. To enable on-chip TE operation, a waveguide polarization rotator may be used. Polarization control devices on the chip, using splitters, rotators, and polarizers, have been extensively studied in telecommunication frequencies. For example, in conventional systems using a QCL source for an indium gallium arsenide-indium phosphide (InGaAs—InP) platform using a polarization splitter and rotator (PSR) may exhibit good performance at 6.15 μm and may remove the need for conventional wafer bonding, however, this platform has a downside in that the platform may require large devices with lengths between two millimeters (mm) to five mm, to achieve ninety percent TM to TE conversion efficiency.

The SOI platform is widely used in integrated photonics and is compatible with CMOS technology. Using buried waveguides may extend its operational range up to 3.8 μm, while suspended silicon waveguides may allow for operation up to fifteen μm. Some conventional PSR technology utilizing silicon nitride (SiN) upper-cladding and SiO₂ lower-cladding may demonstrate excellent performance across a broad wavelength range four μm to 4.4 μm with minimal mode conversion loss of less than 0.25 dB and low crosstalk less than negative eighteen decibel (dB). In this example, the PSR may have a length over four hundred and seventy μm at a wavelength of four μm and approximately one mm in length at a wavelength of 6.9 μm. In another conventional design using the SOI platform, a PSR employing a partially etched grating-assisted coupler for 2.5 μm wavelengths may rotate TE to TM modes, with a device length of about 74.8 μm. Among the two discussed PSRs on the SOI platform, one is notably lengthy, while the other has adequate length but produces TM modes at both outputs. The present disclosure addresses these deficiencies by utilizing a compact (about fifty μm) and efficient PSR on SOI platform using a bifurcated tapered-bent waveguide over a broad wavelength range of 3.1 μm to 3.6 μm. The present embodiments facilitate the generation of both TE modes at an output, with a compact length of only fifty μm and achieves a conversion loss of less than 0.5 dB over the wavelength range 3.1 μm to 3.6 μm.

In some examples, a mid-infrared polarization splitter and rotator may receive a light signal from an optical source such as a QCL. QCLs typically transmit light signals with TM modes which may necessitate using a converter to effectively rotate the TM mode of the light signal to a TE mode for applications which typically can only receive TE modes such as various CMOS technology applications and/or network applications which require receiving and/or transmitting packets of information and/or network switching. In regard to TM modes, a magnetic field component of the light signal is non-existent in the direction of propagation of the light signal. In contrast, for TE modes, an electric field component of the light signal is non-existent in the direction of propagation of the light signal. The light signal in a mid-infrared wavelength range may be transmitted by an optical fiber or similar into a waveguide which includes a structural taper which may widen along a length of the waveguide. The waveguide may be situated on a compact fifty μm silicon-type substrate for support and good signal confinement. Once the light signal enters the tapered section of the waveguide, the TM mode rotates within the tapered section into an additional TE mode.

In some examples, the additional TE mode and the original TE mode of the light signal enter a bifurcation section which splits the two signals along two different waveguide paths for output. One of the paths may propagate the light signal with the additional TE mode to an output for transmission while the other of the paths may propagate the light signal with the original TE mode to another output for transmission. Each of the waveguide paths may include a number of precise curves, bends, and waveguide structures in order to facilitate a two-mode coupled system with exceptionally low insertion losses and polarization conversion losses. Utilizing this design, TE modes may be provided at both outputs thus increasing the number of commercial systems this device may be connected to and/or integrated in. In addition, due to the efficient and optimal compact size, the device may be retrofitted into existing systems with ease which may be appealing to mainstream and specialized applications such as modern and upcoming space technologies, nuclear applications and research, as well as high energy/high frequency physics research which need optical transceivers capable of operation in wavelengths between 3.1 μm and 3.6 μm which are ideal for use in chemical engineering industries for spectral analysis of gases like CO, CH4, OCS, NH3, CO2, and NO.

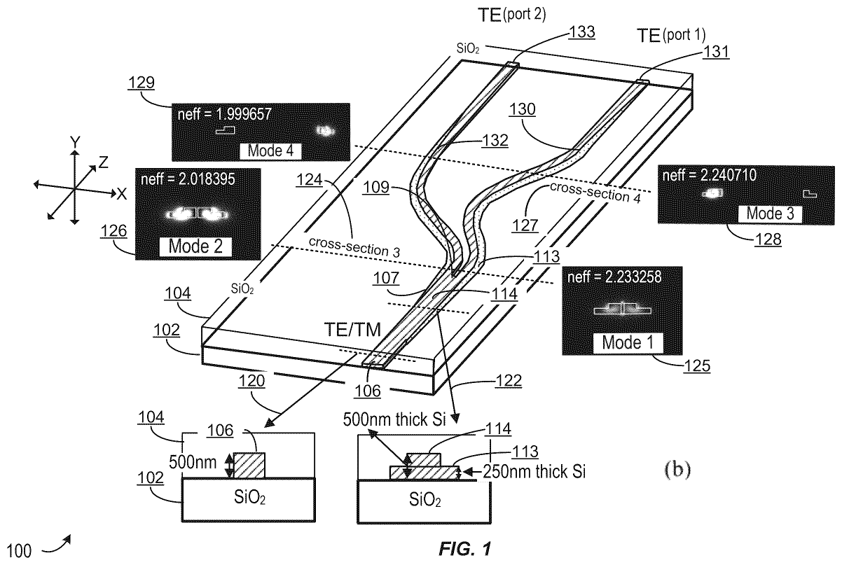

FIG. 1 is an example illustration of a mid-infrared polarization splitter and rotator 100, according to some embodiments. By way of example, the mid-infrared polarization splitter and rotator (MIR-PSR) 100 may include a substrate 102 which may couple to, and/or otherwise support, at least a portion of one or more elements of the present disclosure. The substrate 102 may include one or more stacked layers arranged in any suitable order. The substrate 102 may be formed of any suitable insulator material (e.g., silicon dioxide, SiO₂) or combination of insulator materials (e.g., insulation and/or dielectric oxides). In some examples, the substrate 102 may support at least a portion of a waveguide 106 (e.g., silicon waveguide) that may be configured to receive and/or transmit an input signal (e.g., one or more electromagnetic signal(s)) from an electromagnetic source (e.g., a quantum cascade laser, laser, or similar). The input signal may have a wavelength in a range between two micrometers and fifteen micrometers and may be a multiplexed signal with multiple wavelengths. In some examples, the waveguide 106 may be a buried waveguide, a slot waveguide, or a waveguide material, that may suitably confine and guide the input signal along the length of the substrate 102. In some examples, the waveguide 106 may be a single-mode waveguide or a multi-mode waveguide. The substrate 102 may be substantially rectangular with a length along the z-axis between about fifty micrometers and one-hundred micrometers and a width along the x-axis between twenty micrometers and two hundred micrometers. While these length and width dimensions provide a range of intermediate shapes, it should be readily understood by those skilled in the art that any suitable combination of the length and width are anticipated within this disclosure.

In some embodiments, the waveguide 106 may be sandwiched between the substrate 102 and one or more layers of encapsulation 104 (e.g., SiO₂). The one or more layers of encapsulation 104 may at least partially cover the substrate 102 and the waveguide 106. The one or more layers of encapsulation 104 may be opaque, partially transparent, or completely transparent to one or more wavelengths. The one or more layers of encapsulation 104 may extend over some or all of the substrate 102 and waveguide 106. In addition, or alternatively, the waveguide 106 may be suspended, without being sandwiched between SiO₂ layers which may extend an operational wavelength range up to fifteen μm. In some examples, germanium waveguides may be used which may extend an operational wavelength range beyond fifteen μm.

In some examples, the waveguide 106 may include a taper 107 which widens along the x-axis as the length of the waveguide 106 increases along the z-axis. In some examples, the taper 107 may include an adiabatic linearly expanding structure and/or an adiabatic non-linear expanding structure (e.g., parabolic). The taper 107 may be defined by the waveguide 106. For example, first cross-section 120 along the x-axis depicts a portion of the waveguide 106 as substantially rectangular with a height of around five hundred nanometers (nm) along the y-axis. A second cross-section 122 at a distance from the first cross-section 120 depicts a non-rectangular shape with a two hundred and fifty nanometer (nm) waveguide base 113 and a thinner two hundred and fifty nanometer waveguide top 114 collectively defining the taper 107. In some examples, the waveguide base 113 and the waveguide top 114 may be partially etched waveguides. The taper 107 may be structurally defined by the extent at which the waveguide 106 is etched. The input signal may enter the taper 107 and may be characterized by a mixed signal that may include a transverse electric (TE) mode of zero order or higher (e.g., zero order TE mode, first order TE mode, etc.) and a transverse magnetic (TM) mode of zero order or higher (e.g., zero order TM mode, first order TM mode, etc.). The taper 107 may be configured (e.g., by etching) to condition (e.g., convert by rotation) at least the TM mode into an additional TE mode (e.g., a second order TE mode or similar) while the TE mode of the input signal maintains an original polarization state.

In some embodiments, after the taper 107 has conditioned the TM mode into the additional TE mode, the waveguide 106 guides the input signal into a bifurcation section 109 positioned after the taper 107. By way of example, the bifurcation section 109 may receive the input signal which was conditioned and split the waveguide 106 into a first branch 130 and a second branch 132. Each of the first branch 130 and the second branch 132 may receive the input signal which was conditioned and readily confine the input signal. The first branch 130 and the second branch 132 may be separated by a slot distance (e.g., approximately ninety nm) and may have substantially the same width along the x-axis relative to each other immediately after the bifurcation section 109. In this manner, the first branch 130 and the second branch 132 may be configured to function as a two-mode coupled system which may support a first mode 125 and a second mode 126 along a third cross-section 124, respectively. By way of example, when the TE and TM modes are launched via the input signal, the additional TE mode (the conditioned TM mode) may excite the second mode 126 and the TE mode may excite the first mode 125 at the third cross-section 124.

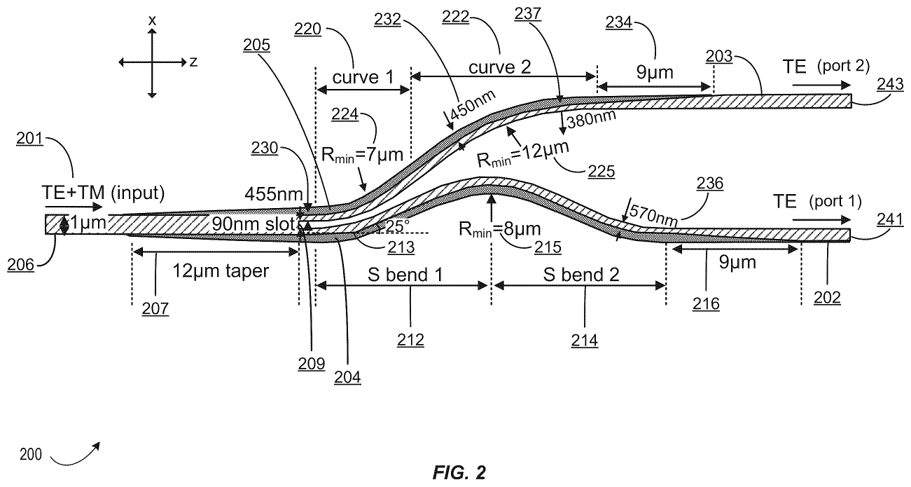

In some embodiments, the first branch 130 and the second branch 132 begin to separate after the bifurcation section 109. As a distance between the first branch 130 and the second branch 132 widens along the length of the waveguide 106, each of the first branch 130 and the second branch 132 may include independent varying tapers with respect to the other branch. The first branch 130 and the second branch 132 may be vertically symmetrical and/or asymmetrical (measured vertically along the y-axis) along the length of the substrate 102. In some examples, the second branch 132 may condition the additional TE mode into a zero order TE mode. For example, at some distances along an x-axis/z-axis plane from the bifurcation section 109, as the first branch 130 widens, the second branch 132 may narrow (e.g., second width 237 compared to first width 236 as discussed later in FIG. 2), or vice versa. In some examples, widening and narrowing may form “L” shape waveguides along the length of the first branch 130 and the second branch 132, respectively. The first branch 130 may include one or more curves after the bifurcation section 109 such that at a fourth cross-section 127, a third mode 128 is excited by the TE mode. In some examples, the second branch 132 may include one or more curves after the bifurcation section 109 such that at the fourth cross-section 127 a fourth mode 129 may be excited by the additional TE mode. The first mode 125 and the third mode 128 may have closely matched effective indices of refraction (e.g., 2.0 to 2.4) that may provide good signal confinement and low crosstalk for the TE mode. The dimensional structure characteristics of the second branch 132 along the length of the substrate 102 may reduce the order of the additional TE mode into a zero order TE mode (e.g., a zero order mode). In some examples, the second mode 126 and the fourth mode 129 may have closely matched effective indices of refraction (e.g., 1.7 to 2.3) such that good signal confinement and low crosstalk for the additional TE mode may be achieved.

In some examples, after the fourth cross-section 127, the first branch 130 and second branch 132 may transition from partially etched waveguides into fully-etched waveguides for output. For example, the first branch 130 may transition over a first etch taper distance (e.g., approximately nine μm) from a partially etched branch shortly after the fourth cross-section 127 to a first fully etched branch for output at a first port 131. The second branch 132 may transition over a second etch taper distance (e.g., approximately nine μm) from a partially etched branch shortly after the fourth cross-section 127 to a second fully etched branch for outputting the zero order TE mode at a second port 133.

FIG. 2 is an example diagram of a mid-infrared polarization splitter and rotator 200, according to some embodiments. The MIR-PSR 200 may represent a top-down view of some of the components of MIR-PSR 100 of FIG. 1. In a non-limiting example, beginning from the left, an input signal 201 which may have transverse electric (TE) modes and transverse magnetic (TM) modes may be received at an input of a waveguide 206. The input of the waveguide 206 may include a width measured along an x-axis (e.g., in a range of 0.5 μm to 1.5 μm). The waveguide 206 may include a taper 207 that may have a length (e.g., between seven μm and fifteen μm) measured along a z-axis after the input but prior to a bifurcation section. The bifurcation section may be defined by a slot 209 which splits the waveguide 206 into a first branch 202 and a second branch 203. The slot 209 may have a width (e.g., between forty nm and one hundred and forty nm) which separates the first branch 202 from the second branch 203. In some examples, at or approximately after the bifurcation section, the first branch 202 and the second branch 203 may have approximately the same widths measured along the x-axis (e.g., between four hundred nm and twelve hundred nm).

In some examples, at a distance after the bifurcation section the first branch 202 may curve along a first S-bend 212 at an angle (e.g., between ten and thirty five degrees) relative to a zero angle along the z-axis. The first branch 202 may then curve in an opposite direction away from the second branch 203 into a second S-bend 214. By way of example, the first S-bend 212 and the second S-bend 214 may have a combined radius of curvature in an x-z plane between three μm and thirteen μm. In addition, or alternatively, the first branch 202 may continue the taper 207 after the bifurcation section such that the first branch 202 may have a first taper 204 which may widen a portion (e.g., the waveguide top 114 of FIG. 1) of the first branch 202 to a first width 236 (e.g., between approximately five hundred nm to six hundred nm). It should be readily understood by those skilled in the art that the first taper 204 of the first branch 202 may widen, narrow, or remain the same width at any point along the length of the waveguide 206 measured along the z-axis in order to suitably minimize a polarization conversion loss and which may provide optimal signal confinement. In some examples, the first branch 202 may transition from the first taper 204 into a first etch taper 216 over a first etch taper distance (e.g., four μm to fourteen μm) for outputting the TE mode by a first port 241.

In some examples, at a distance after the bifurcation section the second branch 203 may curve along a first curve 220 and may include a first radius of curvature 224 (e.g., between two μm and twelve μm).In addition, or alternatively, the second branch 203 may include a second curve 222 which may include a second radius of curvature 225 (e.g., between three μm and twelve μm) curving in the opposite direction of the first curve 220 along the x-z plane such that a first portion (e.g., the waveguide base 113 of FIG. 1) of the second branch 203 may have a width (e.g., between four hundred nm and six hundred nm). After the bifurcation section, the second branch 203 may diverge from the first branch 202 along the z-axis according to the first curve 220 and the second curve 222. In addition, or alternatively, the second branch 203 may continue the taper 207, similar to the first branch 202, after the bifurcation section such that the second branch 203 may have a second taper 205 which may narrow a second portion (e.g., the waveguide top 114 of FIG. 1) of the second branch 203 to a second width 237 (e.g., between approximately three hundred nm and five hundred nm). It should be readily understood by those skilled in the art that the first taper of the second branch 203 may widen, narrow, or remain the same width at any point along the length of the waveguide 206 measured along the z-axis in order to suitably minimize a polarization conversion loss and which may provide optimal signal confinement. In some examples, the second branch 203 may transition from the second taper 205 into a first etch taper 234 over a second etch taper distance (e.g., four μm to fourteen μm) for outputting the additional TE mode by a second port 243.

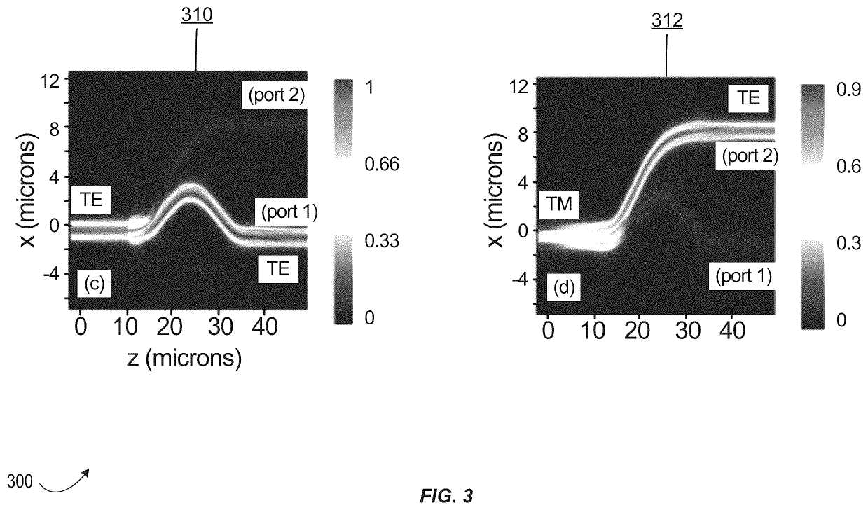

FIG. 3 is an example set of TE/TM mode images 300 of a mid-infrared polarization splitter and rotator, according to some of embodiments. The example images 300 may represent a propagation of light produced by the MIR-PSR 100 of FIG. 1 and/or the MIR-PSR of FIG. 2. By way of example, TE mode image 310 illustrates a propagation of light showing a TE mode of an input signal entering from an input of a waveguide (e.g., waveguide 106 of FIG. 1) and reaching a first port (e.g., first port 131 of FIG. 1) as the TE mode. The bottom axis of the TE mode image 310 represents the z-axis (e.g., such as the z-axis in FIG. 1 or FIG. 2) and the vertical axis of the TE mode image 310 represents the x-axis (e.g., such as the x-axis in FIG. 1 or FIG. 2). Both the z-axis and the x-axis are measured in μm across the MIR-PSR with the z-axis measured between zero and fifty μm and the x-axis measured between negative eight μm and twelve μm. In some examples, when the input signal is launched which includes a TE mode, the TE mode may remain substantially unaltered in its original polarization state.

In some embodiments, when the input signal is launched with a TM mode, the TM mode undergoes conditioning by rotation by a taper in the waveguide (e.g., taper 107 in FIG. 1). TM mode image 312 shows that as light propagates through the taper the TM mode may be rotated to an additional TE mode in the taper and may output a zero order TE mode at a second port. The TM mode is unable to effectively propagate within the first branch of the waveguide due to dimensional taper characteristics of the first branch (as discussed in FIG. 2) thus providing good separation of the input signal and conversion of the TM mode to TE mode at a desired port.

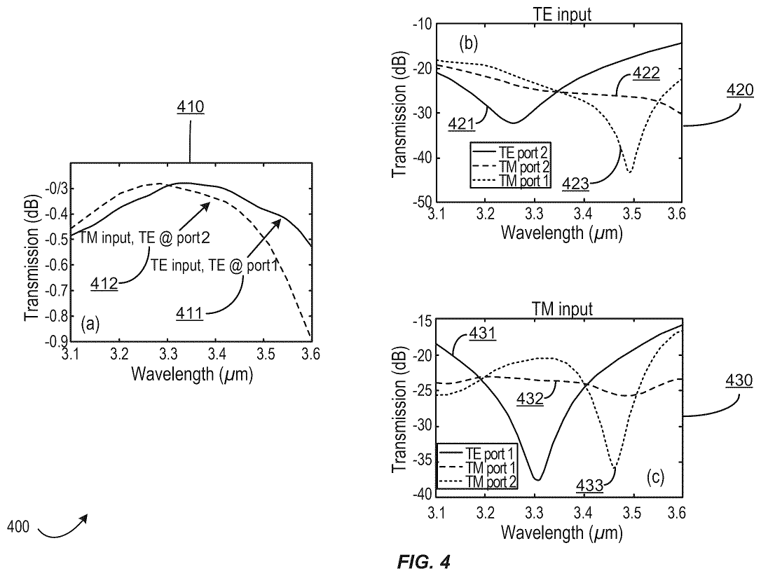

FIG. 4 is an example set of TE/TM transmission spectral responses 400 from a mid-infrared polarization splitter and rotator in a mid-infrared wavelength range, according to some embodiments. The example spectral responses 400 may represent spectral responses produced by the MIR-PSR 100 of FIG. 1 and/or the MIR-PSR of FIG. 2. A first spectral response 410 depicts an insertion loss for an input signal conditioned by the MIR-PSR 100 at a first port and a second port over a wavelength range between 3.1 μm and 3.6 μm. For example, a transverse electric mode and a transverse magnetic (TM) mode may be included within an input signal provided to the MIR-PSR 100 (as discussed in FIG. 1). The TE mode 411 exhibits an insertion loss, of a first output signal, at the first port of a first branch less than 0.5 decibels (dB) for wavelengths between 3.1 μm to 3.6 μm. The TM mode may undergo conditioning by rotation (e.g., as discussed in FIG. 1) which may exhibit an insertion loss, associated with a polarization conversion loss due to the rotation, of a second output signal at a second port (e.g., second port 133 of the second branch 132 of FIG. 1) of less than 0.5 dB between wavelengths 3.1 μm to 3.5 μm, and remains below 0.9 dB across all wavelengths in a range between 3.1 μm to 3.6 μm.

In some examples, a spectral response 420 exhibits crosstalk values between the first and second ports for an input signal providing TE input polarization. For all wavelengths in a range between approximately 3.1 μm to 3.6 μm, first crosstalk values 421 at the second port of the second branch exhibit a crosstalk less than twenty dB across the range of wavelengths. Similarly, second crosstalk values 422, and third crosstalk values 423 both exhibit minimal crosstalk of less than or equal to twenty dB across the range of wavelengths between the ports.

In some examples, a spectral response 430 exhibits crosstalk values between the first and second ports for an input signal providing TM input polarization. For all wavelengths in a range between approximately 3.1 μm to 3.6 μm, first crosstalk values 431 at the second port of the second branch exhibit a crosstalk less than or equal to twenty dB across the range of wavelengths. Similarly, second crosstalk values 432, and third crosstalk values 423 both exhibit minimal crosstalk of less than or equal to twenty dB across the range of wavelengths between the ports.

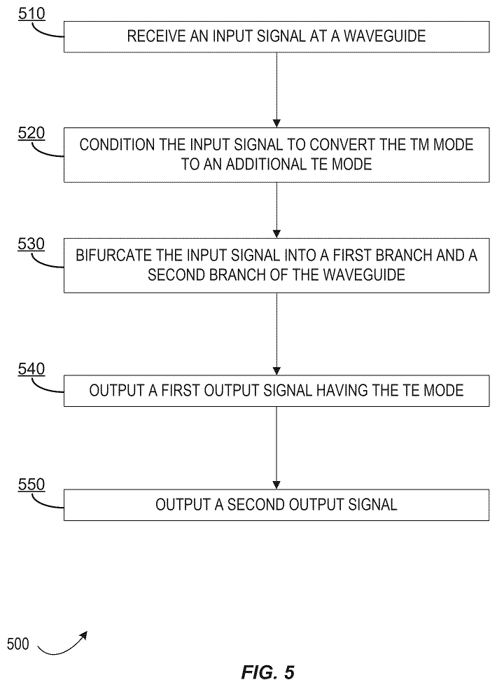

FIG. 5 is an example flow diagram 500 for a mid-infrared polarization splitter and rotator, according to some embodiments. By way of example, the flow diagram 500 may be performed, at least in part, by any suitable combination of the devices of MIR-PSR 100 or MIR-PSR 200 of FIG. 1 and/or FIG. 2. In some embodiments, the flow diagram 500 may include more or fewer steps than the number depicted in FIG. 5. It should be appreciated that the steps of the flow diagram 500 may be performed in any suitable order. The flow may begin at block 510 where a mid-infrared polarization rotator and splitter may receive an input signal at a waveguide. The input signal may be provided by an optical fiber connected to a network for optical communications. In some examples, the input signal may include an amount of encoded data to be received by the MIR-PSR 100 for transmission over the network. The input signal may be light with a wavelength in a range of two to fifteen μm and include transverse electric (TE) modes and transverse magnetic (TM) modes. In some examples, the waveguide may include at least one input port for receiving the input signal and include a taper.

At block 520, the taper may condition the input signal to convert the TM mode to an additional TE mode. The taper may condition at least one TM mode of the input signal by rotating the TM mode into an additional TE mode. The taper may include one or more changes to the waveguide structure such as a narrowing of a first portion of the waveguide while leaving a second portion at a constant width. The taper may be configured to relay the input signal, including the TE mode and additional TE mode to a bifurcation section.

At block 530, the bifurcation section may bifurcate the input signal into a first branch and a second branch of the waveguide. The TE mode may propagate in the same polarization state the TE mode had when the TE mode entered the waveguide along the first branch. The additional TE mode may propagate along the second branch of the waveguide and be conditioned into a zero order TE mode (e.g., from a first order TE mode to a zero order TE mode). The second branch may have effective indices of refraction that are well matched along the length of the second branch in order to adequately confine the signal with low insertion losses.

At block 540, the first branch may output a first output signal having the TE mode at a first port. For example, the first output signal may be provided to one or more networks for data transmission of the input signal. In some examples, the MIR-PSR may be part of a multiplexer, decoder, or encoder connected to the one or more networks. The first output signal may have an insertion loss less than 0.5 dB across wavelengths in a range of 3.1 μm to 3.6 μm.

At block 550, the second branch may output a second output signal having the additional TE mode at a second port. For example, the second output signal may be provided to one or more networks for data transmission of the conditioned input signal. The second output signal may have a polarization conversion loss less than or equal to 0.5 dB across wavelengths in a range of 3.1 μm to 3.5 μm, and exhibit a polarization conversion loss less than or equal to 0.9 dB across wavelengths in a range 3.1 μm to 3.6 μm. In some examples, the first output signal at the first port may include crosstalk of less than 20 dB with the second output signal at the second port.

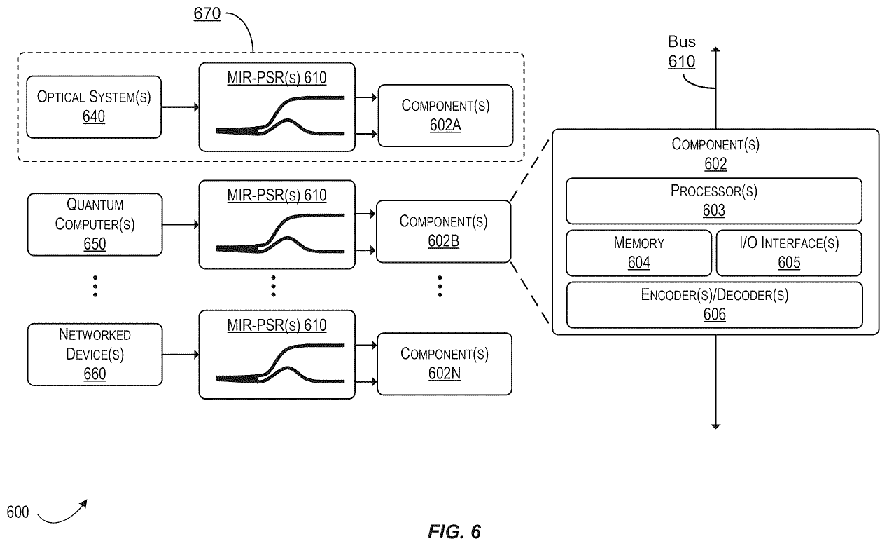

FIG. 6 is an example block diagram 600 for mid-infrared polarization splitter and rotators (MIR-PSR), according to some embodiments. One or more of the MIR-PSR(s) 610 may be the same and include some or all components and structural dimensions as the MIR-PSR 100 of FIG. 1 and/or MIR-PSR 200 of FIG. 2. The MIR-PSR(s) 610 may be coupled to one or more system(s) 670. By way of example, one of the MIR-PSR(s) 610 may receive an input from an optical system(s) 640 (e.g., spectrometer, broadband optical communication, etc.) by way of an optical fiber or similar. The MIR-PSR(s) 610 may perform one or more operation(s) on the input signal (e.g., as in the operations in FIG. 1 and/or FIG. 2) in order to provide two output signals with transvers electric polarizations to one or more component(s) 602 (e.g., computer(s), scientific instrument(s), etc.). In some examples, the MIR-PSR(s) 610A may include any suitable number of MIR-PSR(s) connected in parallel to one or more of optical system(s) 640, quantum computer(s) 650, networked device(s) 660 and/or component(s) 602A, 602B, . . . , 602N, where N is a total number of components. In addition, or alternatively, the one or more system(s) 670 may include any suitable number of devices (e.g., optical system(s), quantum computer(s) 650, networked device(s) 660, etc.) connected to any suitable number of components 602A-602N by way of the MIR-PSR(s) 610.

In some examples, the MIR-PSR(s) 610 may be coupled to systems such as quantum computer(s) 650, networked devices 660 (e.g., telecommunication networks), etc. by way of a photonic integrated chip (PIC) interface. In addition, or alternatively, the MIR-PSR(s) 610 may be retrofitted into existing system(s) 670. For example, the MIR-PSR(s) 610 may be coupled to devices such as multiplexers, demultiplexers, spectrometers, medical probes, network receivers/transmitters, broadband communication networks, chemical sensors, optical isolators, Bragg gratings, amplifiers, optical filters, phase modulators, phased arrays, interferometers, ring resonators, or similar.

In some examples, the component(s) 602 may be coupled to a communication bus 610 (e.g., wired connection, wireless connection, etc.) to transmit signals. The component(s) 602 may include one or more processor(s) 603, non-transitory computer readable medium(s) such as memory 604, an input/output (I/O) interface(s) 605, and/or encoder(s)/decoder(s) 606. The one or more processor(s) 603 may execute machine-readable instructions stored on the memory 604. The one or more processor(s) 603 may include single core or multi-core processors. The memory 604 may be configured in any suitable configuration. For example, memory 604 may be volatile memory such as random access memory (RAM) and/or non-volatile memory such as read-only memory (ROM) and/or flash memory. In addition, or alternatively, the one or more processor(s) 603 and/or memory 604 may function with the I/O interface(s) 605 to receive signals from the MIR-PSR(s) 610. The I/O interface(s) 605 may include any suitable interface including user interfaces such as computers, controllers (e.g., keyboard, mouse, etc.), or similar. In some examples, encoder(s)/decoder(s) 606 may function to receive signals from the MIR-PSR(s) 610. The encoder(s)/decoder(s) 606 may encode the signals for further communication or may decode the signals for analysis and/or storing in memory 604.

As used in this application and in the claims, some or all devices, methods, and apparatus discussed herein may be components in one or more networks for connecting communication paths. For example, the MIR-PSR discussed herein may be used for receiving and/or transmitting data packets to and/or from one network to another network. Multiple MIR-PSR devices may be implemented with the one or more networks and work in conjunction with each other. The networks may include software, hardware, or firmware to operate with the MIR-PSR devices. In some examples, networks may include, but are not limited to, wide area networks (WAN) (e.g., the Internet), local area networks (LAN) (e.g., universities networks), virtual private networks (VPN), internet of things (IoT) networks, any appropriate network/cloud architecture that may facilitate data communications, or combinations thereof.

As used in this application and in the claims, the terms “TE mode” and “TM mode”, etc., are intended to refer to one or more particular polarization modes of the input signal. The use of these terms is not intended to not refer to the input signal by referencing just “the TE mode” or “the TM mode”. It should be readily understood by those skilled in the art that when “the TE mode” or “the TM mode” are referenced herein without referring to “the input signal”, “the light signal”, or similar, the input signal that has one or both of those polarization modes is intrinsically implied to exist. The use of these terms is not intended to indicate that the other mode may not be present or that the signal which provided the particular polarization mode does not exist. For example, “conditioning the TM mode using the taper” does not reference the input signal which has a TM mode polarization, but it is understood to be necessary for the TM mode to exist.

As used in this herein and in the claims, the terms first, second, etc., are intended to distinguish the particular nouns they modify (e.g., branch, input, output, port, etc.) and should not be considered limiting. The use of these terms is not intended to indicate any type of importance, hierarchy, preference of the particular noun. For example, a first branch and a second branch are intended to demonstrate two branches that are not necessarily limited by any importance, hierarchy, preference of the two branches.

As used in this application and in the claims, the singular forms “a”, “an”, and “the” include the plural forms unless the context clearly dictates otherwise. Additionally, the term “includes” means “comprises”. Further, the terms “couple” or “coupled” or “support” or “supported” does not exclude the presence of intermediate elements between the coupled items and/or supported items.

As used in this application and in the claims, the terms “widen”, “widens”, “narrow”, “narrows”, and similar are intended to indicate a dimensional change by increasing or decreasing by comparison to a previous state of the component, previous structure of the component, an existing state at a different location of the component, an existing structure at a different location of the component, or similar unless the context clearly dictates otherwise.

As used in this application and in the claims, ranges such as wavelength ranges include all representative values within the range including the ends of the range. For example, a range of 3.1 to 3.6 includes all values such as 3.1, 3.4, 3.6, and every intermediate value, unless the context clearly dictates otherwise. Additionally, being approximately within the range should be readily understood to be within +/− ten percent of the range end values.

The devices, methods, systems, processes, and/or techniques described herein should not be considered limiting in any way. Instead, the present disclosure is directed toward all non-obvious and novel features and aspects of the various disclosed embodiments, alone and in various combinations and sub-combinations with one another. The disclosed devices, methods, systems, processes, and/or techniques are not limited to any specific aspect or feature or combinations thereof, nor do the disclosed devices, methods, systems, processes, and/or techniques require that any one or more specific advantages be present. Any theories of operation are to facilitate clear and direct explanation, but the disclosed devices, methods, systems, processes, and/or techniques are not limited to such theories of operation.

Although the operations of some of the disclosed methods are described in a particular, sequential order for convenient presentation, it should be understood that this manner of description encompasses any suitable rearrangement, unless a particular ordering is preferred and/or required by specific language set forth below. For example, operations described sequentially may in some cases be rearranged or performed concurrently. Moreover, for the sake of simplicity, the attached figures may not show the various ways in which the disclosed systems, methods, and apparatuses can be used in conjunction with other devices, methods, systems, processes, and/or techniques. Additionally, the description sometimes uses terms like “produce” and “provide”, and similar to describe the disclosed methods. These terms should be considered as high-level abstractions of the actual operations that are performed. The actual operations that correspond to these terms will vary depending on the particular implementation and are readily discernible by one of ordinary skill in the art. Moreover, the description sometimes uses terms like “substantially”, “approximately”, and similar to describe the disclosed devices and apparatus. These terms may represent an equivalence readily understood to one skilled in the art to within a specific percentage (e.g., +/− five percent, +/− ten percent, etc.) for comparison of structures, ratios, dimensions, ranges, operations, or similar.

In some examples, structural elements, geometric relationships, thresholds, criteria, values, procedures, or apparatuses are referred to as “low”, “minimal”, “optimal”, or the like. It will be appreciated that such descriptions are intended to indicate that a selection among many used functional alternatives can be made, and such selections need not be better, smaller, or otherwise preferable to other selections.

What is claimed is:

1. A method using a compact mid-infrared polarization splitter and rotator (PSR) comprising:
receiving an input signal at a waveguide, the input signal having a transverse electric (TE) mode and a transverse magnetic (TM) mode, wherein the TE mode is a zero order or higher TE mode;
conditioning, by a taper of the waveguide, the input signal to convert the TM mode to an additional TE mode, wherein the additional TE mode is a zero order or higher TE mode;
bifurcating, after the conditioning and by a bifurcation section of the waveguide positioned after the taper, the input signal into a first branch and a second branch of the waveguide;
outputting, out of the first branch, a first output signal having the TE mode; and
outputting, out of the second branch, a second output signal having the additional TE mode.

2. The method of claim 1, wherein conditioning further comprises rotating the TM mode into the additional TE mode, and wherein the second branch conditions the additional TE mode of the input signal into the second output signal having a zero order TE mode.

3. The method of claim 1, wherein the input signal has a wavelength in a range between 2.0 μm and 15.0 μm.

4. The method of claim 3, wherein the range is between 3.1 μm and 3.5 μm, and wherein a polarization conversion loss of the second output signal is less than or equal to 0.5 dB.

5. The method of claim 3, wherein a polarization conversion loss of the second output signal is less than 0.9 dB, and wherein an insertion loss at the first output signal is less than or equal to 0.5 dB.

6. The method of claim 3, wherein at least one crosstalk value between the first output signal and the second output signal is less than 20 dB.

7. A device comprising:
a substrate;
a waveguide coupled to the substrate and configured to receive an input signal having a transverse electric (TE) mode and a transverse magnetic (TM) mode, wherein the TE mode is a zero order mode or higher;
a taper of the waveguide configured to condition the input signal to convert the TM mode to an additional TE mode; and
a bifurcation section of the waveguide after the taper forming a first branch and a second branch of the waveguide, wherein the first branch is configured to diverge from the second branch after the bifurcation section, wherein the first branch is configured to output a first output signal having the TE mode, and wherein the second branch is configured to condition the additional TE mode into a zero order TE mode, and configured to output a second output signal having the zero order TE mode.

8. The device of claim 7, wherein the first branch and the second branch are each configured to curve after the bifurcation section.

9. The device of claim 7, wherein the first branch has a first taper which widens after the bifurcation section and the second branch has a second taper which narrows after the bifurcation section.

10. The device of claim 7, wherein the taper includes a length between 7 μm and 15 μm prior to the bifurcation section.

11. The device of claim 7, wherein the substrate has a length which extends along the waveguide, the taper, the first branch, and the second branch, and wherein the length is between 50 μm and 100 μm.

12. The device of claim 7, wherein the first branch includes a first width and the second branch includes a second width, and wherein at a distance after the bifurcation section the first width is greater than the second width.

13. The device of claim 7, wherein the second branch includes a first curve and a second curve, wherein the first curve includes a first radius of curvature between 2 μm and 12 μm, wherein the second curve includes a second radius of curvature between 7 μm and 17 μm, and wherein the first branch includes a first S-bend and a second S-bend which includes a combined radius of curvature between 3 μm and 13 μm.

14. The device of claim 7, wherein the bifurcation section includes a slot with a width between 50 nm and 140 nm.

15. The device of claim 7, wherein the first branch and the second branch have a thickness measured from a surface of the substrate between 400 nm and 600 nm.

16. The device of claim 8, wherein at a distance after the bifurcation section the first branch and the second branch each taper into fully-etched waveguides over a length between 5 μm and 20 μm.

17. An apparatus comprising:
a waveguide configured to receive an input signal having a transverse electric (TE) mode and a transverse magnetic (TM) mode, wherein the TE mode is a zero order mode or higher;
a taper of the waveguide, wherein the taper is configured to condition the input signal to convert the TM mode to an additional TE mode;
a first branch coupled to the taper, wherein the first branch is configured to output a first output signal having TE mode; and
a second branch coupled to the taper, wherein the second branch is configured to condition the additional TE mode into a zero order TE mode, and configured to output a second output signal having the zero order TE mode.

18. The apparatus of claim 17, wherein the first branch and the second branch have equal widths at a bifurcation section of the waveguide, and wherein the first branch and the second branch are each coupled to the taper.

19. The apparatus of claim 17, wherein the first branch curves after the taper at an angle between 10 and 35 degrees.

20. The apparatus of claim 17, wherein the waveguide, taper, first branch, and second branch are at least partially coupled to a substrate, and wherein the waveguide, taper, first branch, and second branch are at least partially encapsulated by a silicon dioxide (SiO2) layer.
